(19) United States
(12) Patent Application Publication
(10) Pub. No.: US 2009/0173922 A1
(43) Pub. Date: Jul. 9, 2009

(54) APPARATUS FOR LIFTING OR PULLING A LOAD

(75) Inventors: Nicolaas Lamphen, Vianen (NL); Wessel Helmens, Papendrecht (NL)

Correspondence Address: PEACOCK MYERS, P.C., 201 THIRD STREET, N.W., SUITE 1340, ALBUQUERQUE, NM, 87102, US

(73) Assignee: Mammoet Europe B.V., Schiedam (NL)

(21) Appl. No.: 12/171,483

(22) Filed: Jul. 11, 2008

(30) Foreign Application Priority Data
Jul. 18, 2007 (NL) 2000758

(51) Int. Cl. B66F 1/08

(52) U.S. Cl. 254/108

(57) ABSTRACT

An apparatus for lifting or pulling a load, characterized by a link chain and co-operating therewith an operating organ for moving the link chain and for the link chain to pass through, wherein the links of the link chain and the operating organ possess mutually engaging bearing faces, and wherein the operating organ possesses a first bearing face and a second bearing face and in addition comprises a hydraulic cylinder for adjusting the distance between the first bearing face and the second bearing face.

### CROSS-REFERENCE TO RELATED APPLICATIONS

This application is a continuation-in-part application of Dutch Patent Application Serial No. 2000758 entitled “Apparatus for Lifting or Pulling a Load”, to Mammoet Europe B.V., inventors Nicolaas Lamphen and Wessel Helmens, residents and citizens of the Netherlands, filed on Jul. 18, 2007, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The invention relates to an apparatus for lifting or pulling a load, in particular a very heavy load.

2. Description of Related Art

In the prior art, so-called ‘strandjacks’ are used for lifting heavy loads. Such strandjacks that are used for lifting heavy loads are coupled with cables, which are subject to elongation caused by the heavy loads. As a consequence, there is a possibility of imbalance when lifting the heavy loads. Moreover, the known strandjacks require much maintenance because they are subject to considerable wear. The use of strandjacks is further disadvantageous because they are consumable goods, which means that lifting heavy loads is liable to high costs.

### BRIEF SUMMARY OF THE INVENTION

It is an object of the invention to provide an apparatus with which these drawbacks are removed completely or in part. It is also an object to provide an alternative for the known strandjack, which is suitable for repeated use.

To this end the apparatus according to the invention is characterized by one or several of the appended claims. It should be noted, that this apparatus can be used for lifting a load, including a suspended load,, as well as for pulling a load, if desired, in horizontal direction.

### BRIEF DESCRIPTION OF THE SEVERAL VIEWS OF THE DRAWINGS

The following explanation refers to the drawing, in which:

FIG. 1a and FIG. 1b show an apparatus according to the invention in a cross-sectional view and an isometric cross sectional view, respectively, and

FIGS. 2a-2d show in a number of successive steps the application of an apparatus for moving a link chain.

Identical reference numerals used in the figures refer to similar parts.

### DETAILED DESCRIPTION OF THE INVENTION

In a first aspect of the invention, the apparatus is characterized by a link chain and co-operating therewith an operating organ for moving the link chain, and for the link chain to pass through. The links of the link chain may be suitably assembled from a plurality of plate-like link elements such that by suitably choosing the number of link elements, each link is able to fulfill the strength requirements of the link chain. The operating organ must then be designed so as to be able to move the link chain as well as the maximum of load to the lifted.

The apparatus according to the invention may then be suitably embodied such that the links of the link chain and the operating organ possess mutually engaging bearing faces. The operating organ or its bearing face or bearing faces thus impart to the links of the link chain a specific orientation, while by activating the operating organ, the link chain can be controlled such as to lift the load.

In a further aspect of the invention, the apparatus is preferably embodied such that the operating organ possesses a first bearing face and a second bearing face and in addition comprises a hydraulic cylinder for adjusting the distance between the first bearing face and the second bearing face. In this way, suitable co-operation of the first bearing face and the second bearing face of the hydraulic cylinder with the bearing faces of the links of the link chain makes easy movement of the link chain possible.

The first bearing face and the second bearing face are preferably each moveable to and from the link chain. When moving the first or second bearing face, respectively, towards the link chain a simple possibility is thus created to adjust to a position for the effective support of the bearing face of one or several links of the link chain. Moving the first bearing face or second bearing face, respectively, into a direction away from the link chain allows this effective co-operation with a bearing face or bearing faces of the link chain to be interrupted so as to subsequently allow the operating organ to be brought into active contact with a following link of the link chain. The manner in which this works is explained below.

For safety purposes it is desirable for the mutually engaging bearing faces of the links and the operating organ to be provided with projections and recesses that are geared to each other such that when these projections and recesses intermate, the bearing faces of the operating organ will be prevented from moving cross-directionally in relation to the link chain.

As mentioned above, the operating organ controls the link chain by changing the distance between the first bearing face and the second bearing face of the operating organ. In order to effectively move the links it is, therefore, desirable for the hydraulic cylinder to have a stroke of at least one link length.

To allow the link chain to be moved in relation to the operating organ in a continuous operation, it is further advantageous for the first bearing face and the second bearing face of the operating organ to be independently moveable away from and towards the link chain. This will be further explained by way of the figure legend.

In still another aspect of the invention, it is advantageous that there is also provided a horizontalizer with which the operating organ is coupled. With this it is easy to control the operating organ such that the load suspended from the apparatus can be kept exactly horizontal. This is of particular importance because in practice, when lifting heavy loads, several apparatuses according to the invention are used simultaneously to lift the respective load, so that alignment of the load becomes essential.

The simplest manner of controlling the load is thus by the horizontalizer being provided with hydraulic balancing cylinders for adjusting the position of the operating organ.

Hereinafter, the invention will be further illustrated by way of a schematic exemplary embodiment of an apparatus according to the invention and its application.

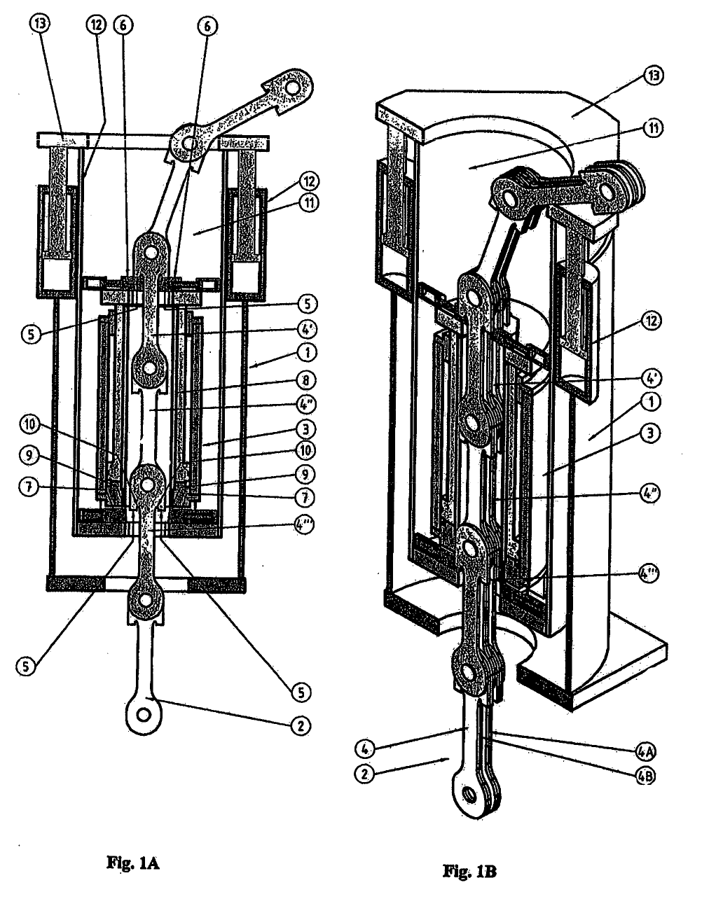

Referring first to FIG. 1a and FIG. 1b, reference numeral 1 generally identifies the apparatus according to the invention. This apparatus 1 serves for lifting a heavy load, which is not shown in the figures.

The apparatus 1 comprises a link chain 2 and engaging said link chain an operating organ 3 for moving the link chain 2. The fact that the link chain 2 is fed through the operating organ 3 is clearly visible.

FIG. 1b shows that the various links 4 of the link chain 2 comprise a number of adjacent link plates 4A, 4B. The number of such link plates 4A, 4B to be used has to be geared to the maximum weight of the load to be lifted.

FIG. 1a clearly shows that the links 4′ and 4″ of the link chain 2 as well as the operating organ 3 possess mutually engaging bearing faces 5, 6, and 7.

The operating organ 3 possesses a first bearing face 6 that acts on or may act on a bearing face 5 of the first link 4′ and a second bearing face 7 that acts or may act on a bearing face 5 of a second link 4″′ located below the first link 4′.

Both the first bearing face 6 and the second bearing face 7 are further moveable cross-directionally in relation to the links 4′, 4″, and 4″′ of the link chain 2, such that each of these is adjustable in the direction towards and in the direction away from the link chain 2. Moreover, this movement of the first bearing face 6 and the second bearing face 7 can occur independently of each other.

To allow the links 4′, 4″, and 4″′ of the link chain 2 to be fed through the operating organ 3, said operating organ 3 further possesses a hydraulic cylinder 8 for changing the distance between the first bearing face 6 and the second bearing face 7 of the operating organ 3. To this end the hydraulic cylinder 8 has a stroke of preferably at least one whole length of the link 4′, 4″, and 4″′.

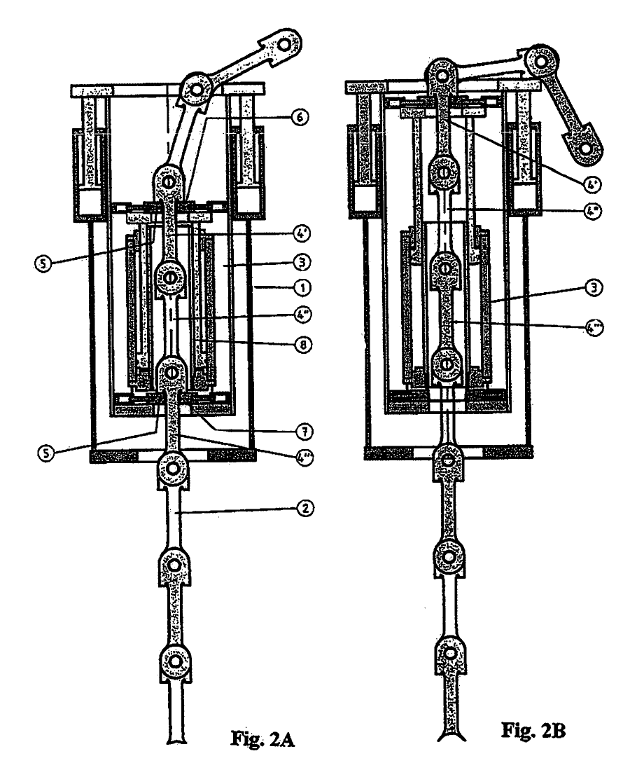

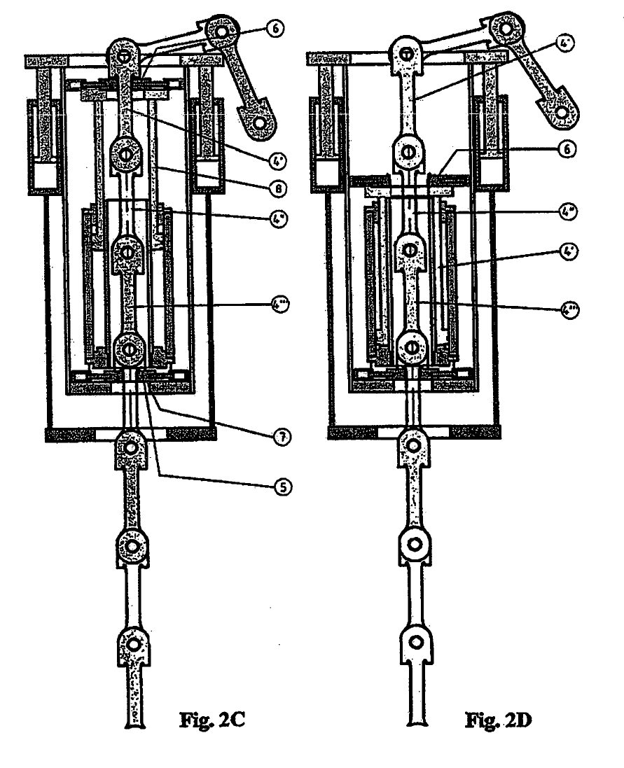

The hydraulic cylinder 8 for moving the links of the link chain 2 is operated such that the operation of moving the first and second bearing faces 6 and 7 towards or away from the link chain 2 is adjusted thereto. In this way it can be achieved that said bearing faces 6 and 7 always engage bearing faces 5 of successive links 4′, 4″, and 4″′ of the link chain 2, so as to allow the link chain 2 to be moved by the hydraulic cylinder 8. This will be explained further with reference to the FIGS. 2a-2d.

For the safe operation of the bearing faces 6 and 7 of the operating organ 3, it is further desirable for the bearing faces 5 of the links 4′, 4″, and 4″′ and the mutually engaging bearing faces 6 and 7 of the operating organ 3 to possess projections 9 and recesses 10 that are geared to each other such that when these projections 9 and recesses 10 engage, a cross-directional movement of the bearing faces 6 and 7 of the operating organ 3 in relation to the link chain 2 is prevented.

FIG. 1a and FIG. 1b further show that a horizontalizer 11 is provided with which the operating organ 3 is coupled. In the case shown, this is realized by the fact that the horizontaliser 11 possesses hydraulic balancing cylinders 12 operating a suspension surface 13 that supports the operating organ 3, so that by suitably operating the balancing cylinders 12, the position of the operating organ 3 can be adjusted appropriately. The balancing cylinders 12 afford the additional advantage that continuous measuring of the load is possible by measuring the hydraulic pressure in the balancing cylinders 12.

Hereinafter the application of the apparatus 1 according to the invention shown in FIGS. 1a and 1b will be explained with reference to the FIGS. 2a-2d.

FIG. 2a shows the apparatus 1 according to the invention wherein the same has a starting position in which the link chain 2 is locked due to each the first bearing face 6 and the second bearing face 7 being actively engaged with bearing faces 5 of links 4′ and 4″′ located above each other.

For feeding the link chain 2 through the operating organ 3 the hydraulic cylinder 8 is first activated to some extent so as to allow the second bearing face 7, located at the lower side of the operating organ 3, to be removed from the links of the link chain 2. This creates space, allowing the links 4 of the link chain 2 to be moved upward through the operating organ 3, which is shown in FIG. 2b by the fact that the hydraulic cylinder 8 has been activated such as to complete a full stroke equaling at least one whole link length. As a result, the link 4″′, which in FIG. 2a was still located substantially below the operating cylinder 3, is now located entirely at the level of the operating cylinder 3 and is surrounded thereby, as shown in FIG. 2b.

After reaching the position shown in FIG. 2b, the second bearing face 7 can be moved in the direction of the link chain 2, allowing this second bearing face 7 to come into active contact with the bearing face 5 of the link 4″′. This is shown in FIG. 2c.

Subsequently, the first bearing face 6 of the hydraulic cylinder 8 can be moved such that it moves away from the links 4 of the link chain 2, which simultaneously allows the hydraulic cylinder 8 to be moved back to its starting position as shown in FIG. 2a. This is represented in FIG. 2d. Subsequent to reaching the position shown in FIG. 2d, the first bearing face 6 of the operating organ 3 is moved in the direction of the link 4″ so as to bring the same into active contact with the bearing face 5 of said link 4″, as a result of which the operating organ 3 wholly returns to the starting position shown in FIG. 2a and a new sequence of moving the links of the link chain 2 can be carried out.

What is claimed is:

1. An apparatus for lifting or pulling a load, said apparatus comprising a link chain and co-operating therewith an operating organ for moving the link chain and for the link chain to pass through.

2. An apparatus according to claim 1, wherein the links of the link chain and the operating organ possess mutually engaging bearing faces.

3. An apparatus according to claim 2, wherein the operating organ possesses a first bearing face and a second bearing face and in addition comprises a hydraulic cylinder for adjusting the distance between the first bearing face and the second bearing face.

4. An apparatus according to claim 3, wherein the first bearing face and the second bearing face are each moveable to and from the link chain.

5. An apparatus according to claim 4, wherein the mutually engaging bearing faces of the links and the operating organ are provided with projections and recesses that are geared to each other such that when these projections and recesses intermate, and wherein the first and second bearing faces of the operating organ will be prevented from moving cross-directionally in relation to the link chain.

6. An apparatus according to claim 3, wherein the hydraulic cylinder has a stroke of at least one link length.

7. An apparatus according to claim 4, wherein the first bearing face and the second bearing face are independently moveable away from and towards the link chain.

8. An apparatus according to claim 1, wherein there is also provided a horizontalizer with which the operating organ is coupled.

9. An apparatus according to claim 8, wherein the horizontalizer is provided with hydraulic balancing cylinders for adjusting the position of the operating organ.
